(19) United States
(12) Patent Application Publication
(10) Pub. No.: US 2009/0041391 A1
(43) Pub. Date: Feb. 12, 2009

(54) IMAGE SENSING DEVICE

(75) Inventors: Ying-Chung Wang, Hsinchu City (TW); Hao-Ping Hong, Hsinchu County (TW); Jui-Ching Yang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/115,592

(22) Filed: May 6, 2008

Related U.S. Application Data
(60) Provisional application No. 60/954,336, filed on Aug. 7, 2007.

(51) Int. Cl. G06K 9/20; H04N 5/225

(52) U.S. Cl. 382/321; 348/207.99; 348/E05.024

(57) ABSTRACT

An image sensing device is disclosed. The image sensing device comprises a plurality of image sensor units disposed separately and a plurality of wave guiding units. Each wave guiding unit is disposed on each corresponding image sensor unit.

### CROSS REFERENCE TO RELATED APPLICATIONS

This application claims priority of U.S. Patent Application No. 60/954,336, filed on Aug. 7, 2007, the entirety of which is incorporated by reference herein.

### BACKGROUND OF THE INVENTION

1. Field of the Invention

The present invention relates to an electronic device, and in particular relates to an image sensing device.

2. Description of the Related Art

Fingerprint sensing and matching is a reliable and widely used technique for personal identification or verification. In particular, a common approach to fingerprint identification involves scanning a sample fingerprint or an image thereof and storing the image and/or unique characteristics of the fingerprint image. The characteristics of a sample fingerprint may be compared to information for reference fingerprints already in a database to determine proper identification of a person, such as for verification purposes.

However, conventional fingerprint sensors suffer from issues such as crosstalk, loss propagation, and diffraction. Accordingly, an image sensing device such as a fingerprint sensor capable of solving these issues is desirable.

### BRIEF SUMMARY OF THE INVENTION

A detailed description is given in the following embodiments with reference to the accompanying drawings.

In one embodiment, an image sensing device is disclosed. The image sensing device comprises a plurality of image sensor units disposed separately and a plurality of wave guiding units. Each wave guiding unit is disposed on each corresponding image sensor unit.

### BRIEF DESCRIPTION OF THE DRAWINGS

The present invention can be more fully understood by reading the subsequent detailed description and examples with references made to the accompanying drawings, wherein:

FIG. 1 is an embodiment of the structure of an image sensing device according to the invention.

FIG. 2 is a cross section diagram of the image sensing device of FIG. 1.

FIG. 3 shows another embodiment of the structure of an image sensing device according to the invention.

FIG. 4 is a diagram illustrating the cross section of the image sensing device of FIG. 3.

FIG. 5 shows another embodiment of the structure of an image sensing device according to the invention.

FIG. 6 is a diagram illustrating the cross section of the image sensing device of FIG. 5.

FIG. 7 shows another embodiment of the image sensing device according to the invention.

FIG. 8 is the cross section view of the embodiment shown in FIG. 7.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

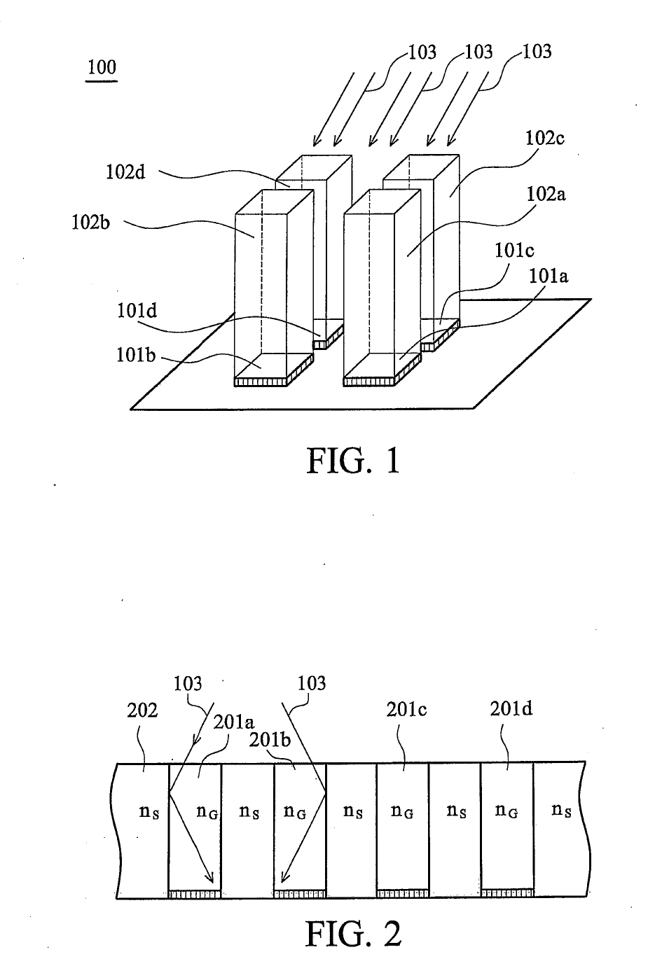

FIG. 1 is an embodiment of the structure of an image sensing device according to the invention. With reference to FIG. 1, an image sensing device 100 comprises image sensor units 101a, 101b, 101c, 101d, and wave guiding units 102a, 102b, 102c, 102d. Image sensor units 101a, 101b, 101c, 101d do not lie closely adjacent to one another on a surface. Rather, they lie separately on the surface with a certain distance to one another. Incident light 103 is guided by wave guiding units 102a, 102b, 102c, and 102d into image sensor units 101a, 101b, 101c, and 101d separately. Wave guiding units 102a, 102b, 102c, and 102d can have refractive index n_{G} greater than that of its surrounding material. Therefore, light can have a total internal reflection if certain incident angle requirement is met.

FIG. 2 is a cross section diagram of the image sensing device of FIG. 1. With reference to FIG. 2, surrounding material 202 is filled into the gaps between wave guiding units 201a, 201b, 201c, and 201d. The refractive index n_{G} of wave guiding units 201a, 201b, 201c, and 201d is greater than refractive index n_{S} of the surrounding material 202. Effective guiding of the incident light 103 thus can be achieved.

The embodiment shown in FIG. 1 and FIG. 2 provides two functions: (1) light isolation and (2) low loss propagation. Light isolation means that the wave guiding units keep the light in the guides isolated and free of crosstalk. The light propagating in one wave guiding unit will not interfere with the light in another wave guiding unit. Low loss propagation means that when a low loss material is used to fabricate the wave guiding units, light propagating through one wave guiding unit can reach its corresponding image sensor unit with very little loss.

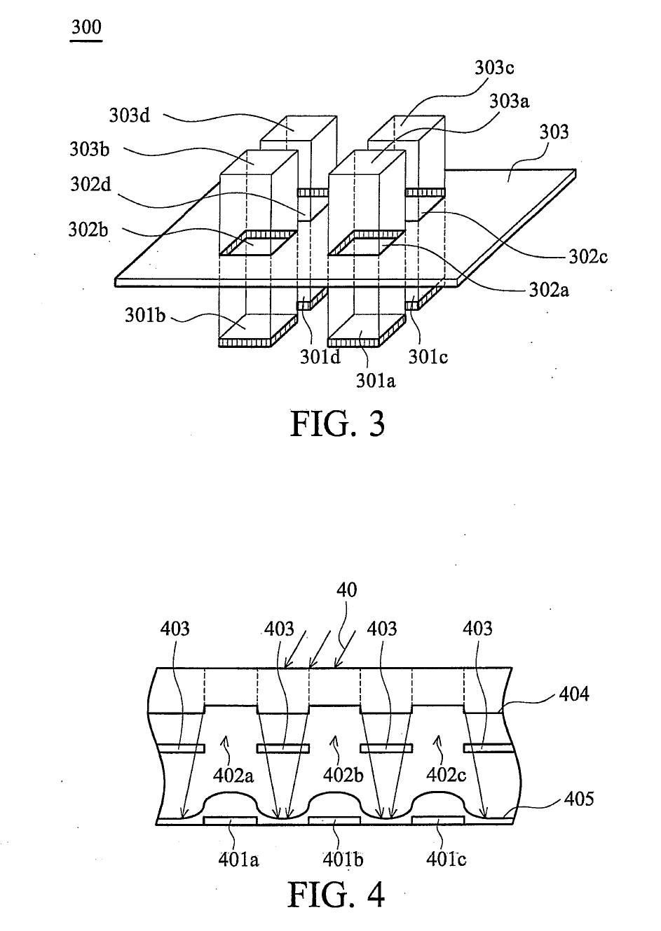

FIG. 3 shows another embodiment of the structure of an image sensing device according to the invention. With reference to FIG. 3, the image sensing device 300 comprises image sensor units 301a, 301b, 301c, 301d, wave guiding units 303a, 303b, 303c, 303d, and a light shielding layer 303 with openings 302a, 302b, 302c, and 302d. The light shielding layer 303 can be a metal layer. The openings 302a, 302b, 302c, 302d can regenerate a pattern of light source substantially matching the shape and location of the image sensor units 301a, 301b, 301c, and 301d. The light shielding layer 303 can also effectively shield light from reaching an area where no image sensor unit is placed. The refractive index n_{G} of the wave guiding units 303a, 303b, 303c, 303d is greater than n_{S} of the surrounding material (not shown). The wave guiding units 303a, 303b, 303c, 303d can effectively guide the incident light into image sensor units 301a, 301b, 301c, and 301d.

In another embodiment, n_{G} can be close to or equal to n_{S}. The openings 302a, 302b, 302c, 302d can still regenerate light source pattern and shield part of the light. The regenerated light source pattern causes a diffraction pattern on the surface of image sensor units 301a, 301b, 301c, and 301d. The diffraction pattern will substantially match the pattern and location of image sensor units 301a, 301b, 301c, and 301d if the distance between the light shielding layer 303 and the image sensor surface is small. This is near-field diffraction.

FIG. 4 is a diagram illustrating the cross section of the image sensing device of FIG. 3. With reference to FIG. 4, the numbering 40 refers to light, and a light source pattern 404 is regenerated by a light shielding layer 403 with openings 402a, 402b, and 402c. n_{G} is equal to n_{S} in this case. A diffraction pattern 405 is generated on the surface of image sensing units 401a, 401b, and 401c. As shown in FIG. 4, although there is small amount of distortion, the diffraction pattern 405 substantially matches the pattern and location of the image sensing units 401a, 401b, and 401c.

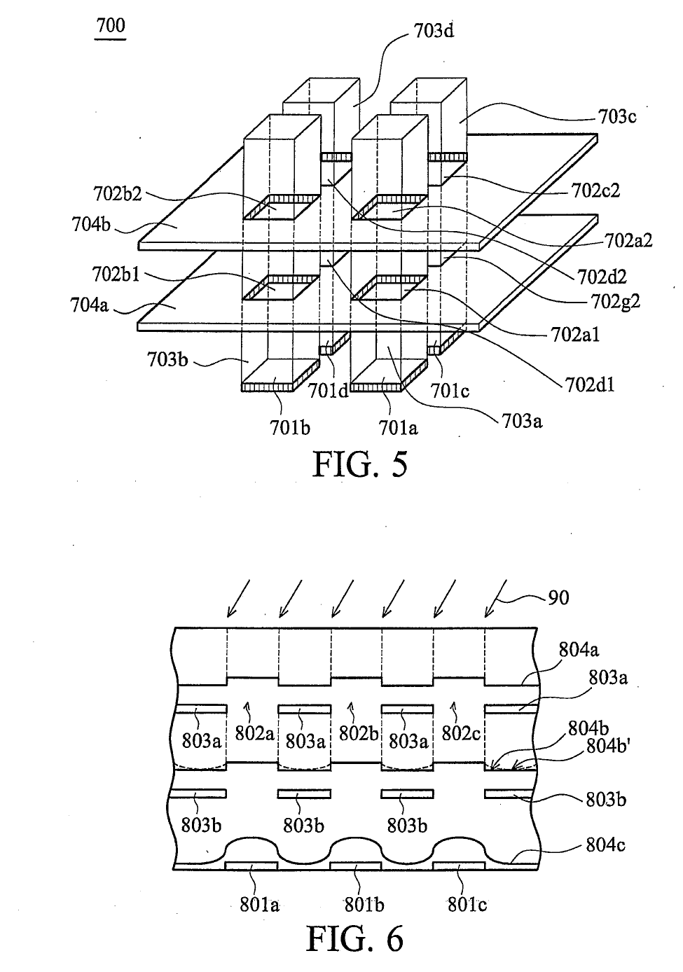

FIG. 5 shows another embodiment of the structure of an image sensing device according to the invention. With reference to FIG. 5, the image sensing device 700 comprises image sensor units 701a, 701b, 701c, 701d, wave guiding units 703a, 703b, 703c, 703d, and light shielding layers 704a and 704b with openings 702a1, 702b1, 702c1, 702d1, 702a2, 702b2, 702c2, and 702d2. The light shielding layer 704a and 704b can be metal layers. The openings 702a1, 702b1, 702c1, 702d1, 702a2, 702b2, 702c2, and 702d2 can regenerate a pattern of light source substantially matching the shape and location of the image sensor units 701a, 701b, 701c, 701d. The light shielding layer 704a and 704b can also effectively shield light from reaching an area where no image sensor unit is placed. The refractive index n_{G} of the wave guiding units 703a, 703b, 703c, 703d is greater than n_{S} of the surrounding material. The wave guiding units 703a, 703b, 703c, and 703d can effectively guide the incident light into image sensor units 701a, 701b, 701c, 701d.

In another embodiment, n_{G} can be close to or equal to n_{S}. In this case, the openings 702a1, 702b1, 702c1, 702d1, 702a2, 702b2, 702c2, and 702d2 still regenerates light source pattern and shields part of the light. The regenerated light source pattern causes a diffraction pattern on the surface of image sensor units 701a, 701b, 701c, and 701d. The diffraction pattern will substantially match the pattern and location of image sensor units 701a, 701b, 701c, and 701d if the distance between the light shielding layer 704a and the image sensor surface is small. This is near-field diffraction.

FIG. 6 is a diagram illustrating the cross section of the image sensing device of FIG. 5. With reference to FIG. 6, a light source pattern 804a is regenerated by a light shielding layer 803a with openings 802a, 802b, and 802c. The light shielding layer 803a prevents crosstalk between adjacent lights which are passing through different openings. n_{G} is equal to n_{S} in this case.

Subsequently, a diffraction pattern 804b′ is generated on the shielding layer 803b. Again, the diffraction pattern 804b′ is shielded to prevent crosstalk between adjacent lights which are passing through different openings. A light source pattern 804b is generated on the shielding layer 803b.

The light source pattern 804b causes a diffraction pattern 804c on the surface of image sensing units 801a, 801b, and 801c. As shown in FIG. 6, although there is small amount of distortion, the diffraction pattern 804c substantially matches the pattern and location of the image sensing units 801a, 801b, and 801c.

As shown in this embodiment, each shielding layer serves to isolate adjacent lights using openings. A diffraction pattern will not substantially interfere with an adjacent light because the shielding layers shield “tail” of a diffraction pattern, preventing further diffraction and crosstalk. The embodiment can have an effective isolation function. As to the propagation loss, since the distance between each layer is small, propagation loss would not be a problem. This embodiment resembles the wave guide approach in that they both achieve certain degree of light isolation and low loss propagation.

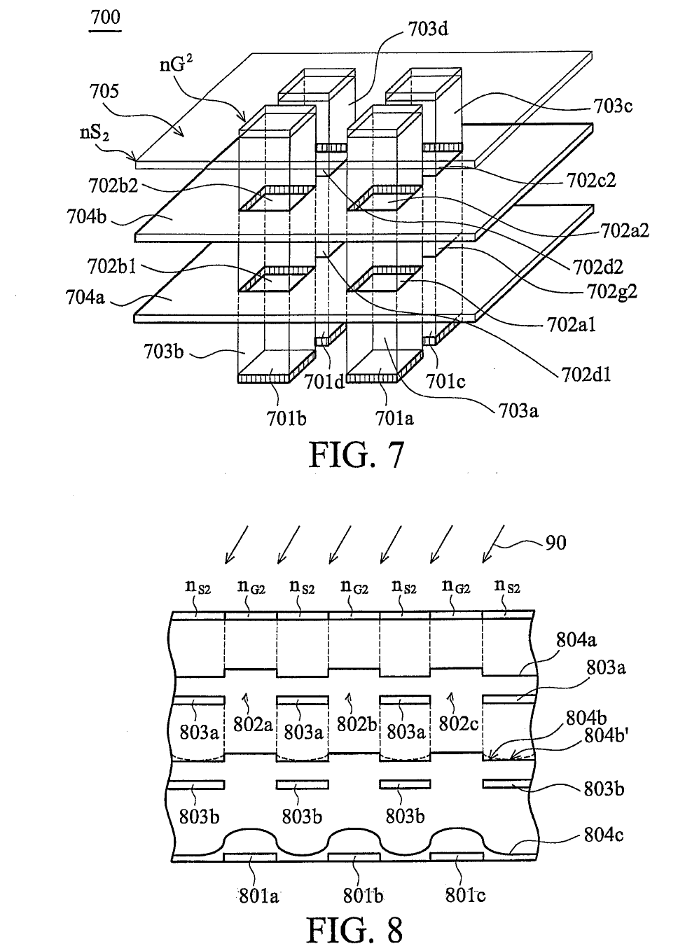

FIG. 7 and FIG. 8 show another embodiment of the image sensing device. The image sensing device illustrated by FIG. 7 is the same as that of FIG. 5 except that a cover layer 705 is positioned on top of the image sensing device. The portions directly positioned on top of the wave guiding units 703a-703d have a refractive index n_{G2} and other portions have a refractive index n_{S2}. In one embodiment, n_{G2} is greater than n_{S2} so that lights can be effectively guided into the wave guiding units 703a-703d. In another embodiment, n_{G2} is the same as n_{S2} and the two portions (n_{G2} and n_{S2}) are made of the same material. FIG. 8 is the cross section view of the embodiment shown in FIG. 7. As shown, numbering 90 refer to light, and different refractive indexes (n_{G2} and n_{S2}) are implemented in the cover layer. In another embodiment, n_{G2} and n_{S2} can be the same and the cover layer is a uniform layer made of the same material.

All embodiments of the image sensing device can be used to detect fingerprint if a finger, with proper illumination, is pressing upon or placed upon the upper surface of an image sensing device.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image sensing device, comprising:
a plurality of image sensor units disposed separately; and
a plurality of wave guiding units, wherein each wave guiding unit is disposed on one of the image sensor units.

2. The image sensing device as claimed in claim 1, further comprising:
materials with a refractive index equal to or less than that of the wave guiding units.

3. The image sensing device as claimed in claim 2, further comprising:
at least a light shielding layer with a plurality of openings therein, wherein each wave guiding unit is in each corresponding opening, and the light shielding layer is higher than all the image sensor units.

4. The image sensing device as claimed in claim 3, wherein the light shielding layer is a metal layer.

5. The image sensing device as claimed in claim 2, further comprising:
at least two light shielding layers, each including a plurality of openings, wherein each opening in the upper light shielding layer corresponds to each opening in the lower light shielding layer, and each wave guiding unit is in each corresponding opening, and the lower light shielding layer is higher than all the image sensor units.

6. The image sensing device as claimed in claim 5, wherein at least one of the light shielding layers is a metal layer.

7. The image sensing device as claimed in claim 5, wherein the light shielding layers are made of metal.

8. The image sensing device as claimed in claim 2, wherein there is a predetermined distance between the adjacent light shielding layers.

9. The image sensing device as claimed in claim 2, further comprising:
a cover layer disposed on top of the image sensing device.

10. The image sensing device as claimed in claim 9, wherein the cover layer is a uniform layer made of same materials.

11. The image sensing device as claimed in claim 9, wherein the cover layer includes a first portion contacting the wave guiding units and a second portion not contacting the wave guiding units, wherein the first and second portions are formed of different materials.

12. An image sensing device, comprising:
a plurality of image sensor units disposed separately; and
at least a light shielding layer with a plurality of openings, the light shielding layer shielding a portion of a light source and forming a light pattern by the openings, wherein the light pattern substantially matches locations of the image sensor units.

13. The image sensing device as claimed in claim 12, wherein the light pattern substantially matches shapes of the image units.

14. The image sensing device as claimed in claim 12, wherein the shielding layer is a metal layer.
